(19) United States
(12) Patent Application Publication
(10) Pub. No.: US 2021/0373561 A1
(43) Pub. Date: Dec. 2, 2021

(54) MOVABLE BODY CONTROL DEVICE, MOVABLE BODY, MOVABLE BODY MANAGEMENT SYSTEM, MOVABLE BODY CONTROL METHOD, AND PROGRAM

(71) Applicant: HONDA MOTOR CO., LTD., Tokyo (JP)

(72) Inventors: Taiki Iimura, Wako-shi (JP); Shinichiro Kobashi, Wako-shi (JP); Takeshi Echizenya, Wako-shi (JP); Tomokazu Sakamoto, Wako-shi (JP); Takayuki Nakagawara, Tokyo (JP); Etsuko Takasugi, Tokyo (JP)

(21) Appl. No.: 17/330,468

(22) Filed: May 26, 2021

(30) Foreign Application Priority Data
Jun. 1, 2020 (JP) 2020-095435

(51) Int. Cl. G05D 1/02; H04L 29/08

(52) U.S. Cl. CPC G05D 1/0212; H04L 67/12

(57) ABSTRACT

A movable body control device controls a movable body on which a worker who performs a work task at a workplace is capable of boarding and which is capable of traveling in a state where the worker is boarding. The movable body control device includes: an acquisition part that acquires information based on information regarding the progress of the work task of the worker; and a control part that controls movement of the movable body based on the information which is acquired by the acquisition part.

### CROSS-REFERENCE TO RELATED APPLICATION

Priority is claimed on Japanese Patent Application No. 2020-095435, filed on Jun. 1, 2020, the contents of which are incorporated herein by reference.

### BACKGROUND

### Field of the Invention

The present invention relates to a movable body control device, a movable body, a movable body management system, a movable body control method, and a program.

### Background

In the related art, an automatic vehicle allocation system is disclosed which: receives a signal from a position correction device that is located on a route on which an autonomous vehicle is capable of traveling and that specifies the position of an autonomous vehicle which travels in the vicinity thereof; corrects a self-position on the basis of the received signal; and guides a vehicle along a travel route on which a self-position corrected based on map information is set (for example, Japanese Unexamined Patent Application, First Publication No. 2001-005524).

As a related art, a technique described in Japanese Unexamined Patent Application, First Publication No. 2006-285639 is disclosed.

### SUMMARY

The related art described above guides the vehicle without considering a work task performed by a worker who boards a movable body, and convenience may be impaired for the worker.

An aspect of the present invention aims to provide a movable body control device, a movable body, a movable body management system, a movable body control method, and a program that can improve convenience of a worker.

A movable body control device according to a first aspect of the present invention is a movable body control device that controls a movable body on which a worker who performs a work task at a workplace is capable of boarding and which is capable of traveling in a state where the worker is boarding, the movable body control device including: an acquisition part that acquires information based on information regarding the progress of the work task of the worker; and a control part that controls movement of the movable body based on the information which is acquired by the acquisition part.

A second aspect of the present invention is the movable body control device according to the first aspect described above, wherein the work task may be a work task by which the worker confirms information that is indicated by equipment which is provided at the workplace.

A third aspect of the present invention is the movable body control device according to the first or second aspect described above, wherein the information regarding the progress of the work task may be information which is generated by operating a terminal device that is carried by the worker and that receives information which is input by the worker in accordance with the work task.

A fourth aspect of the present invention is the movable body control device according to any of the first to third aspects described above, wherein the information regarding the progress of the work task may be information indicating that the work task has started, information that is indicated by equipment as a target of the work task, information indicating that the worker has confirmed information that is indicated by equipment which is provided at the workplace, or information indicating that the work task has been completed.

A fifth aspect of the present invention is the movable body control device according to any of the first to fourth aspects described above, wherein the control part may move the movable body to a position associated with a position of a work target at which the worker performs the work task based on the information acquired by the acquisition part.

A sixth aspect of the present invention is the movable body control device according to the fifth aspect described above, wherein the position associated with the position of the work target at which the worker performs the work task may be a position at which the worker is scheduled to arrive after getting off the movable body and then stopping at a plurality of work targets.

A seventh aspect of the present invention is the movable body control device according to any of the first to sixth aspects described above, wherein the control part may move the movable body in accordance with the progress of the work task after the worker gets off the movable body, in accordance with information generated based on the information regarding the progress of the work task of the worker and a work schedule performed by the worker.

An eighth aspect of the present invention is a movable body on which the movable body control device according to any of the first to seventh aspects described above is mounted.

A ninth aspect of the present invention is a movable body management system, including: the movable body control device according to any of the first to eighth aspects described above; and a server device that acquires the information regarding the progress of the work task of the worker and that provides information based on the information regarding the progress of the work task generated based on the acquired information to the movable body control device.

A tenth aspect of the present invention is the movable body management system according to the ninth aspect described above, wherein the server device may generate information based on the information regarding the progress of the work task for moving the movable body based on information regarding the progress of the work task of the worker and a work schedule including a plurality of work tasks and may provide the generated information to the movable body control device.

An eleventh aspect of the present invention is a movable body control method by way of a computer that controls a movable body on which a worker who performs a work task at a workplace is capable of boarding and which is capable of traveling in a state where the worker is boarding, the movable body control method including: acquiring information based on information regarding the progress of the work task of the worker; and controlling movement of the movable body based on the information which is acquired.

A twelfth aspect of the present invention is a computer-readable non-transitory recording medium which includes a program causing a computer that controls a movable body on which a worker who performs a work task at a workplace is capable of boarding and which is capable of traveling in a state where the worker is boarding to: acquire information based on information regarding the progress of the work task of the worker; and control movement of the movable body based on the information which is acquired.

According to the first to twelfth aspects described above, the movable body control device controls the movement of the movable body using the information regarding the progress of the work task, and thereby, it is possible to improve convenience of a worker. For example, the movable body automatically moves to a position suitable for the worker, and thereby, the worker can easily access the movable body in accordance with the progress of the work task.

According to the sixth aspect described above, since the movable body moves to a position at which the worker is scheduled to arrive after stopping at a plurality of work targets, the worker can board the movable body promptly after stopping at the work targets and proceed to the next destination.

### BRIEF DESCRIPTION OF THE DRAWINGS

FIG. 1 is a view showing an example of a functional configuration of a movable body management system.

FIG. 2 is a perspective view showing a movable body.

FIG. 3 is a perspective view of a movable body in a case where a seat part is raised by an operation of a lifting mechanism.

FIG. 4 is a view showing a first support part and a second support part.

FIG. 5 is a view showing the first support part and the second support part in a case where the height of the seat part is raised.

FIG. 6 is a view showing an example of another functional configuration included in the movable body.

FIG. 7 is a view showing an example of work information stored in a storage part of a management device.

FIG. 8 is a view showing a work schedule.

FIG. 9 is a view showing an example of an image.

FIG. 10 is a view showing an example of a behavior of the movable body.

FIG. 11 is a view showing another example of a behavior of the movable body.

FIG. 12 is a view showing an example of an image displayed on a display part of a terminal device.

FIG. 13 is a sequence view showing an example of a flow of a process performed by a movable body management system.

FIG. 14 is a view showing an operation of a movable body according to a second embodiment.

FIG. 15 is a view showing generation of a work schedule according to a third embodiment.

### DESCRIPTION OF EMBODIMENTS

Hereinafter, a movable body management system including a movable body control device, a movable body, a movable body management system, a movable body control method, and a program according to embodiments of the present invention will be described with reference to the drawings. The movable body control device controls a movable body on which a worker who performs a work task at a workplace is capable of boarding and which is capable of traveling in a state where the worker is boarding. The movable body control device is, for example, mounted on the movable body described above and performs a variety of processes in cooperation with another device included in the movable body management system.

### First Embodiment

### Overall Configuration

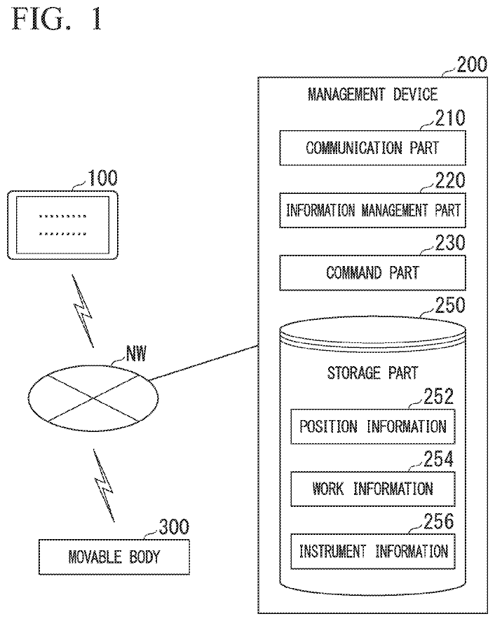

FIG. 1 is a view showing an example of a functional configuration of a movable body management system 1. The movable body management system 1 includes a terminal device 100, a management device 200, and a movable body 300. These communicate with one another via a network NW. The network NW includes the Internet, a WAN (Wide Area Network), a LAN (Local Area Network), a public line, a provider device, a dedicated line, a wireless base station, and the like. A control device that is included in the management device 200 or the movable body 300 is an example of a “movable body control device”.

### Terminal Device

The terminal device 100 is, for example, a smartphone, a tablet terminal, or the like. In the terminal device 100, an application program, a browser, or the like for utilizing a service provided by the movable body management system 1 is started, and the service described below is supported. In the following description, it is assumed that the terminal device 100 is a tablet terminal, and the application program (service application) for receiving the service has started. The service application communicates with the management device 200 in response to an operation of a worker, transmits information that is input by the worker to the management device 200, and provides information on the basis of information that is received from the management device 200.

### Management Device

The management device 200 includes, for example, a communication part 210, an information management part 220, a command part 230, and a storage part 250. The information management part 220 and the command part 230 are implemented, for example, by a processor such as a CPU (Central Processing Unit) as hardware executing a program (software). Some or all of the information management part 220 and the command part 230 may be implemented by hardware (a circuit part including circuitry) such as an LSI (Large-Scale Integration), an ASIC (Application-Specific Integrated Circuit), a FPGA (Field-Programmable Gate Array), or a GPU (Graphics-Processing Unit) or may be implemented by software and hardware in cooperation. The program may be stored in advance in a storage device (a storage device including a non-transitory storage medium) such as a HDD or a flash memory, or may be stored in a removable storage medium (a non-transitory storage medium) such as a HDD (Hard Disc Drive), a DVD, or a CD-ROM and be installed in the storage device by the storage medium being mounted on a drive device. The storage part 250 is implemented by a DVD, a RAM (Random-Access Memory), a flash memory, or the like. Position information 252, work information 254, instrument information 256, and the like are stored in the storage part 250. The position information 252 includes position information of the movable body 300 in a time series. Details of other information are described later.

The communication part 210 is, for example, a wireless communication module for connecting to a network NW or communicating directly with another terminal device or the like. The communication part 210 performs wireless communication on the basis of Wi-Fi, DSRC (Dedicated Short-Range Communications), Bluetooth (Registered Trademark), or other communication standards.

The information management part 220 manages information that is provided by the terminal device 100 or the movable body 300. For example, the information management part 220 stores the information that is provided by the terminal device 100 or the movable body 300 in the storage part 250. The information management part 220 provides the information stored in the storage part 250 or information based on the information stored in the storage part 250 to the terminal device 100 or the movable body 300.

The command part 230 gives a command to the movable body 300 on the basis of the information that is provided by the terminal device 100. The command is a command regarding a direction in which the movable body 300 proceeds, the height of the movable body 300, and the like. The command may include a speed, a route, trajectory information, and the like when the movable body proceeds to a destination. The trajectory information is information in which the position and the speed in a time series when the movable body 300 moves are associated with each other.

### Movable Body

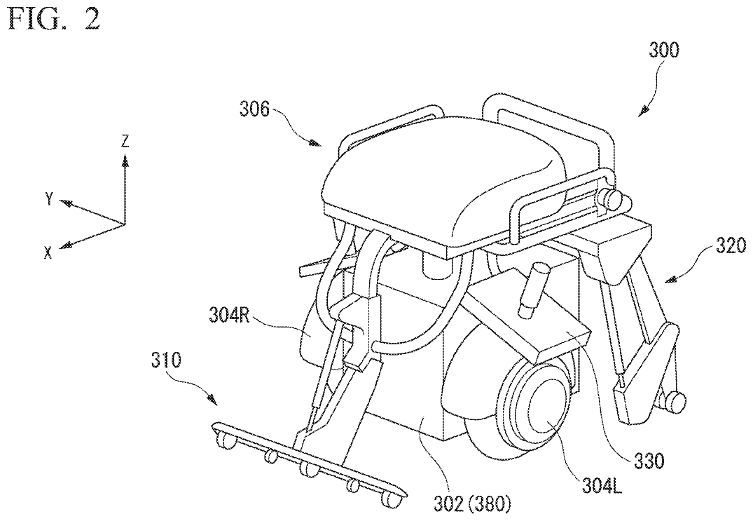

FIG. 2 is a perspective view showing the movable body 300. Hereinafter, a front-to-rear direction of the movable body may be referred to as an X direction, a lateral direction may be referred to as a Y direction, and a direction perpendicular to the X direction and the Y direction may be referred to as a Z direction. The movable body 300 is a movable body on which a worker who performs a work task at a workplace is capable of boarding and which is capable of adjusting the height of a boarding part on which the worker boards.

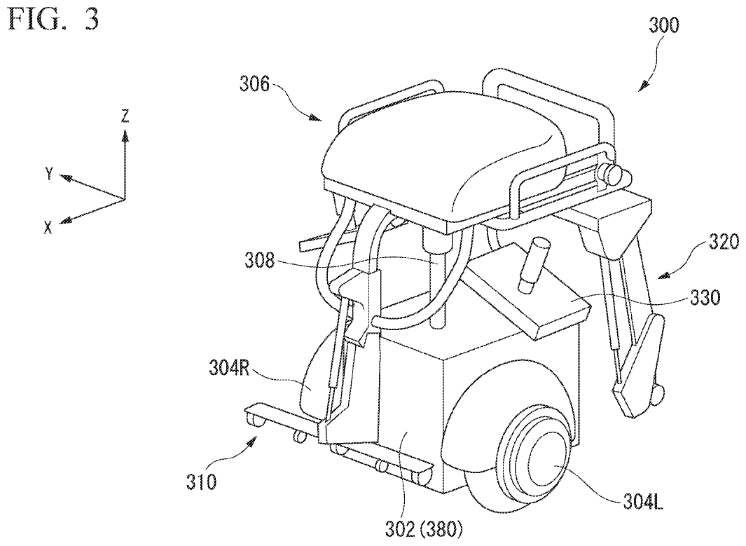

The movable body 300 includes, for example, a base body 302, a wheel 304R and a wheel 304L that are attached to the base body 302, a seat part 306 like a cushion on which a passenger is seated, a lifting mechanism 308 (refer to FIG. 3 described later) that drives the seat part 306, a first support part 310, a second support part 320, and an operation part 330. A control device 380 described later, a motor, a battery, and the like are accommodated inside the base body 302.

The present embodiment is described using an example in which the movable body 300 as shown in FIG. 2 is used; however, the movable body is not limited to a movable body 300 as shown in FIG. 2 and may be a movable body in which a worker rides on a step in a state of standing. A mechanism such as an endless track may be used in place of the wheel 304R and the wheel 304L.

The wheel 304R is provided on a +Y direction side of the movable body 300. The wheel 304L is provided on a −Y direction side of the movable body 300. The wheel 304R and the wheel 304L are driven by the motor. The seat part 306 is provided above the base body 302. An upper surface of the seat part 306 is a seat surface that supports the hip of the passenger from below. The seat part 306 is supported by the base body 302 via the lifting mechanism 308. Details of the first support part 310 and the second support part 320 are described below.

The operation part 330 includes an operation element for the worker to control an operation of the movable body 300. For example, the operation element is an operation element for controlling the speed of the movable body 300, a braking operation, and the lifting mechanism 308.

FIG. 3 is a perspective view of the movable body 300 in a case where the seat part 306 is raised by an operation of the lifting mechanism 308. FIG. 3 is a perspective view of the movable body 300 when the seat part 306 is raised by the operation of the lifting mechanism 308. The lifting mechanism 308 is an actuator that is formed of, for example, a motor and a ball screw. However, the configuration of the lifting mechanism is not limited thereto and may be, for example, a hydraulic mechanism or a rack-and-pinion mechanism. The lifting mechanism 308 is controlled by the control device 380 and supports the seat part 306 such that the seat part 306 is capable of being raised and lowered relative to the base body 302.

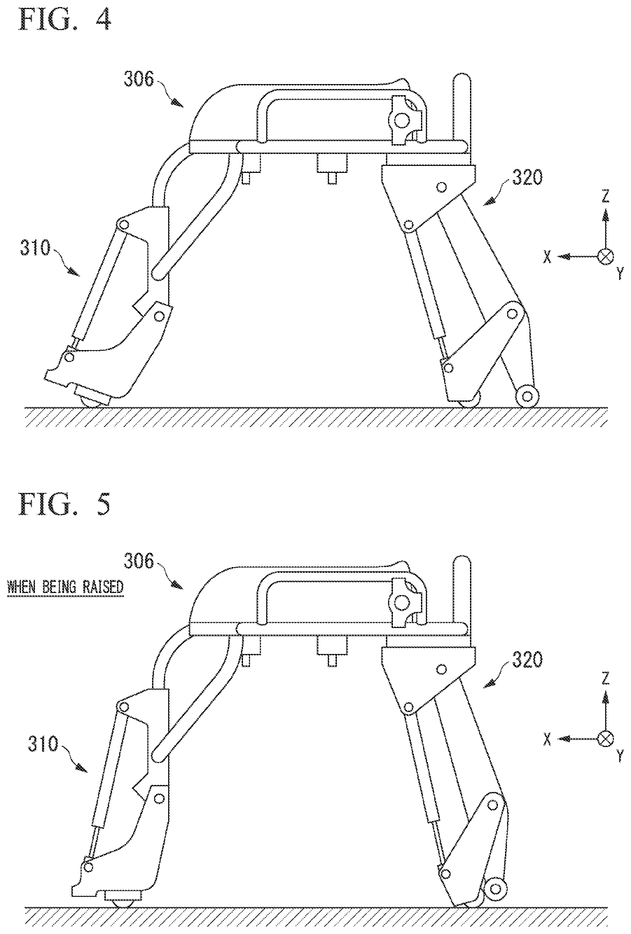

FIG. 4 is a view showing the first support part 310 and the second support part 320. FIG. 4 and FIG. 5 described below are views of the seat part 306, the first support part 310, and the second support part 320 when seen from the −Y direction. In FIG. 4 and FIG. 5, configurations other than the seat part 306, the first support part 310, and the second support part 320 are omitted.

The first support part 310 is provided on an end part in the +X direction of the seat part 306, extends in a ground direction, and supports the movable body 300 as needed. The second support part 320 is provided on an end part in the −X direction of the seat part 306, extends in the ground direction, and supports the movable body 300 as needed.

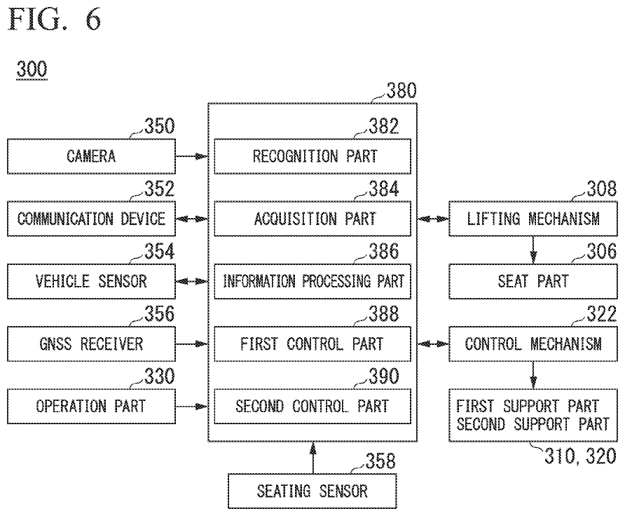

The first support part 310 and the second support part 320 are controlled, for example, by a control mechanism 322 (refer to FIG. 6) such as an actuator formed of a motor and a ball screw. The control mechanism 322 is controlled by a control device 380. A ground contact part such as a wheel or a stopper is provided at end parts of the first support part 310 and the second support part 320 on a side close to the ground surface. The first support part 310 and the second support part 320 may have a passive mechanism that comes into contact with the ground in accordance with the height of the seat part 306 by the self-weight of the first support part 310 or the second support part 320, a spring mechanism (suspension), or the like. Further, the first support part 310 and the second support part 320 have a lock mechanism of a movable portion, and the lock mechanism is operated by a control.

For example, when the worker boards the movable body 300, the lifting mechanism 308 lowers the seat part 306 to a lower position on the basis of control of the control device 380. In accordance with the height of the seat part 306, the ground contact part of the first support part 310 and the second support part 320 is controlled to be located on the ground.

Thereby, for example, the stability when the worker boards the movable body 300 is ensured. When the movable body 300 travels, the first support part 310 and the second support part 320 may be controlled such that the ground contact part is not located on the ground. Thereby, the travel performance of the movable body 300 is improved.

FIG. 5 is a view showing a state of the first support part 310 and the second support part 320 in a case where the height of the seat part 306 is raised. For example, it is assumed that in a case where the worker is boarding the movable body 300, the lifting mechanism 308 raises the height of the seat part 306 on the basis of the control of the control device 380. In this case, in accordance with the height of the seat part 306, for example, the ground contact part of the first support part 310 and the second support part 320 are controlled to be located on the ground by the control of the control mechanism 322 described above, the passive mechanism, or the like. For example, in a case where the height of the seat part 306 of FIG. 5 is higher than the height of the seat part 306 of FIG. 4 described above, each of the first support part 310 and the second support part 320 is controlled to approach the center of the seat part 306 with respect to the X direction, and the ground contact part is located on the ground. Further, at this time, the first support part 310 and the second support part 320 are locked by the lock mechanism described above. Thereby, for example, even in a case where the height of the seat part 306 is raised, the stability of the movable body 300 is ensured.

The first support part 310 and the second support part 320 may have a stretchable or retractable configuration in place of the functional configuration described above. In this case, when the seat part 306 is controlled, the first support part 310 and the second support part 320 may extend and be located on the ground, or the first support part 310 and the second support part 320 may emerge from a storage part and be located on the ground.

FIG. 6 is a view showing an example of another functional configuration included in the movable body 300. The movable body 300 includes, for example, a camera 350, a communication device 352, a vehicle sensor 354, a GNSS receiver 356, a seating sensor 358, a secondary battery 360, a control device 380, and the like in addition to the functional configuration described above.

The camera 350 is set, for example, at a position where the periphery (for example, the front) of the movable body 300 can be imaged. For example, the camera 350 is provided on an end portion of the operation part 330 on the +X direction side or the like. The movable body 300 may include a plurality of cameras 350. The plurality of cameras 350 are each set to positions having optical axes in different directions. According to this setting, any directions represented by the X direction and the Y direction can be within an imaging range. The movable body 300 may have, in addition to the camera 350, a functional configuration capable of detecting a situation and an object around the movable body 300 such as a laser range finder or an infrared sensor.

The communication device 352 is, for example, a wireless communication module for connecting to the network NW or communicating directly with another terminal device or the like. The communication device 352 performs wireless communication on the basis of Wi-Fi, DSRC, Bluetooth, or other communication standards.

The vehicle sensor 354 is a sensor that detects the speed, the acceleration, the angular speed around the vertical axis, or the like of the movable body 300.

The GNSS receiver 356 measures the self-position on the basis of radio waves arriving from a GNSS satellite (for example, a GPS satellite). The GNSS receiver 356 outputs the positioning result to the control device 380.

The seating sensor 358 is a sensor that outputs an ON signal to the control device 380 in a case where a worker is boarding the movable body 300. The seating sensor 358 is, for example, a pressure sensor provided on the seating sensor 358. The seating sensor 358 may be an IMU (Inertial Measurement Unit). In this case, the control device 380 determines that the worker is not boarding the movable body 300 when the detection result of the IMU matches a detection result in a case where the worker is not boarding the movable body 300.

The control device 380 includes, for example, a recognition part 382, an acquisition part 384, an information-processing part 386, a first control part 388, and a second control part 390. These functional configurations are implemented, for example, by a processor such as a CPU as hardware executing a program (software). Some or all of these functional configurations may be implemented by hardware (a circuit part including circuitry) such as an LSI, an ASIC, a FPGA, or a GPU or may be implemented by software and hardware in cooperation. The program may be stored in advance in a storage device (a storage device including a non-transitory storage medium) such as a HDD (Hard Disk Drive) or a flash memory or may be stored in a removable storage medium (a non-transitory storage medium) such as a DVD or a CD-ROM and be installed in the storage device by the storage medium being mounted on a drive device.

The recognition part 382 recognizes an object around the movable body 300 on the basis of an image captured by the camera 350. The recognition part 382 recognizes, for example, the presence or absence of an obstacle, the situation of a road on which the movable body travels, the kind of an object that is present in the vicinity, the position of the object, and the like.

The acquisition part 384 acquires information that is acquired by the communication device 352 or acquires information that is acquired by the vehicle sensor 354 or the GNSS receiver 356. The acquisition part 384 acquires, from the terminal device 100 that is carried by the worker and that receives information which is input by the worker in accordance with the work task, information based on the information regarding the progress of the work task of the worker. Details of the information based on the information regarding the progress of the work task will be described later.

The information-processing part 386 manages the information that is acquired by the acquisition part 384 or controls each piece of equipment (equipment other than the equipment as a control target of the first control part 388 and the second control part 390) included in the movable body 300.

The first control part 388 controls the motor of the movable body 300 to cause the movable body 300 to travel.

The first control part 388 causes the movable body 300 to travel on the basis of an operation of the operation part 330 or a command of the management device 200. The first control part 388 controls the speed of the movable body 300, the movement such as the direction of movement, or the height of the seat part 306 on the basis of the information that is acquired by the acquisition part 384.

The second control part 390 controls the lifting mechanism 308 or the control mechanism 322. The second control part 390 controls the lifting mechanism 308 on the basis of an operation of the operation part 330 or a command of the management device 200.

The second control part 390 controls the height of the seat part 306 on the basis of the information that is acquired by the acquisition part 384. For example, the second control part 390 acquires an adjustment degree of the height of the seat part 306 and the height of the instrument from the management device 200 and controls the control mechanism 322 such that the instrument can be readily confirmed in a state where the worker is seated on the basis of the acquired information.

### Process Regarding Work Task

The worker boards the movable body 300, moves within a predetermined facility, and performs a work task. The facility is, for example, a facility having a predetermined size such as a substation but is not limited thereto. The work task is, for example, a work task in which a worker performs confirmation, an operation, or treatment of the equipment in a facility or the like. The following embodiment is described using an example in which a worker performs a work task of confirming the information indicated by an instrument in a facility such as a substation.

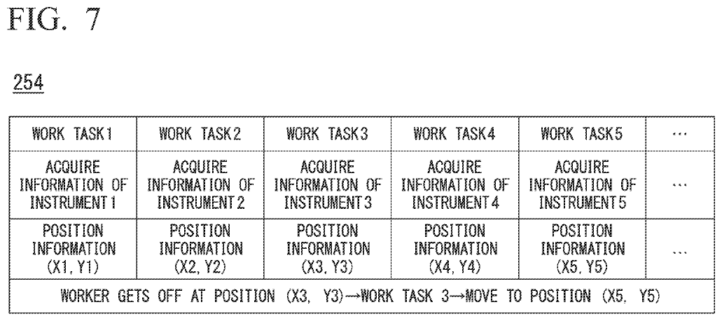

FIG. 7 is a view showing an example of the work information 254 that is stored in the storage part 250 of the management device 200. The work information 254 is information in which a work schedule, the type of work task that is performed by a worker, the equipment (instrument) of a work target, the arrangement place of a work target, the position (position information) where the movable body 300 waits when the worker performs a work task of a work target, the height of a work target (instrument), an upper speed limit, a movement speed, and the like are associated with one another. The work schedule is associated with a scenario regarding the movement of the movable body 300. Such a scenario is, for example, a scenario regarding the movement of the movable body 300 after the worker gets off the movable body 300 to perform a work task.

In the example of FIG. 7, the work schedule includes a scenario in which the movable body 300 moves to a position associated with a work task 5 after the worker gets off the movable body 300 to perform a work task 3.

The position associated with the work task is a position where it is estimated that the worker moves after finishing the work task (a position associated with a position of a work target at which the worker performs the work task). This position may be set in the past action history of the worker or may be set by an administrator.

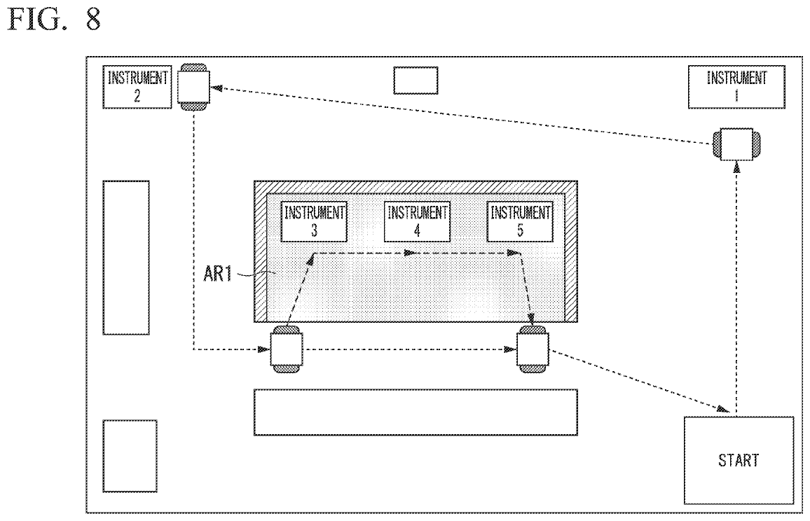

FIG. 8 is a view showing a work schedule. For example, the work schedule is a schedule of confirming the information indicated by the instrument in order of an instrument 1, an instrument 2, an instrument 3, an instrument 4, and an instrument 5. For example, the worker boards the movable body 300, confirms the instrument 1 and the instrument 2, and then gets off the movable body 300 near the instrument 3 in order to confirm the instrument 3, the instrument 4, and the instrument 5. This is because an area AR1 where the instrument 3, the instrument 4, and the instrument 5 are provided is an area that is not suitable for traveling of the movable body 300 such as a gravel road. The worker moves in the area AR1 on foot and confirms the instrument.

For example, when a worker operates the terminal device 100, starts a service application, and performs a predetermined operation, the service application of the terminal device 100 and the management device 200 cooperate with each other. For example, identification information of the movable body 300 used by the worker, a work schedule, equipment of a work target included in the work schedule, information in which the equipment and map information of the facility are associated with each other (for example, information as shown in FIG. 8) are displayed on a display part of the terminal device 100.

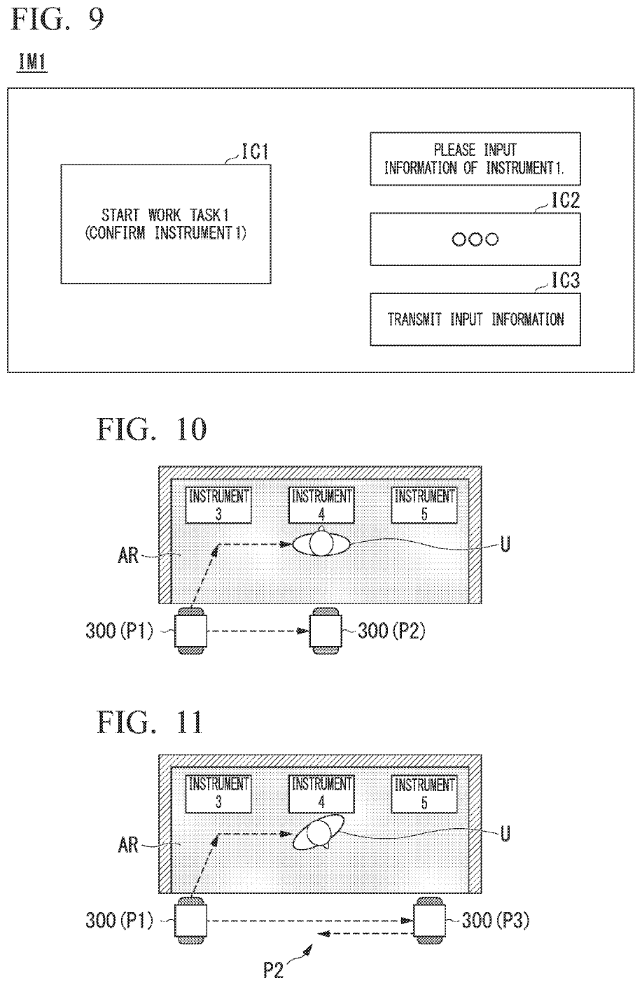

In a case where the worker boards a designated movable body 300 and, for example, arrives near the instrument 1, an image IM is displayed on the display part of the terminal device 100. FIG. 9 is a view showing an example of an image IM1. The movable body 300 may move by an operation of the worker. The movable body 300 may move on the basis of a command of the management device 200. In this case, the management device 200 causes the movable body 300 to travel toward a destination on the basis of the position information of the movable body 300.

The image IM may be displayed in a case where the worker performs a predetermined operation of the terminal device 100, or the terminal device 100 may display the image IM on the display part in a case where the movable body 300 arrives near the instrument 1 on the basis of the position information of the movable body 300.

The image IM includes an icon IC1, an icon IC2, and an icon IC3. The icon IC1 is a button that is operated when a work task 1 is started. The icon IC2 is an icon to which information indicated by the instrument 1 is input. For example, in a case where the icon IC1 is operated, when the worker operates the icon IC2, a numeric keypad or the like is displayed on the display part. The worker operates the numeric keypad and inputs the information indicated by the instrument 1. When the worker operates the icon IC3, the information input to the icon IC2 is transmitted to the management device 200.

Information indicating that the icon IC1, the icon IC2, or the icon IC3 is operated is an example of “information regarding the progress of the work task (information which is generated by operating a terminal device that is carried by the worker and that receives information which is input by the worker in accordance with the work task)”. Information indicating that the icon IC1 is operated is an example of “information indicating that the work task has started”.

Information that is indicated by the instrument 1 and that is input to the icon IC2 is an example of “information that is indicated by equipment” or “information indicating that the worker has confirmed information that is indicated by equipment which is provided at the workplace”. Information indicating that the icon IC3 is operated is an example of “information indicating that the work task has been completed” or “information indicating that the worker has confirmed the information indicating equipment which is provided at the workplace”.

“Information based on information regarding the progress of the work task” is, for example, information (for example, information for controlling the movable body 300) transmitted to the movable body 300 by the management device 200 in response to the management device 200 acquiring the information regarding the progress of the work task described above.

In accordance with the operation of the icon, the management device 200 transmits a movement position to the movable body 300. The movable body 300 acquires the movement position that is transmitted by the management device 200. Then, the movable body 300 proceeds to the movement position that is provided by the management device 200. That is, the movable body 300 moves the movable body 300 in accordance with the progress of the work task after the worker gets off the movable body 300 on the basis of the work schedule and the information regarding the progress of the work task. In a case where an icon regarding another instrument is operated, the movable body moves to a predetermined position in accordance with the progress of the work task.

In the example of FIG. 8 described above, in a case where the operation of an icon regarding the instrument 3 (the instrument 4 or the instrument 5) is performed in the same manner as described above, the movable body 300 moves to a position (a position associated with a position of a work target at which the worker performs the work task) where the worker will proceed after confirming the instrument 5 and receives the worker. That is, the movable body 300 moves to a position at which the worker is scheduled to arrive after getting off the movable body 300 and then stopping at a plurality of work targets. Thereby, the worker is able to board the movable body 300 promptly near the instrument 5 and at a position suitable for further proceeding to the next destination without returning to the position where the worker gets off the movable body 300. As a result, the movable body 300 can move the movable body 300 on the basis of the progress of the work task of the worker.

FIG. 10 is a view showing an example of a behavior of the movable body 300. The above embodiment has been described using an example in which the movable body 300 moves near the instrument 5 after the worker gets off the movable body 300; however, the movable body 300 may be moved in accordance with the motion of the worker as shown in FIG. 10. For example, the movable body 300 may not enter the area AR1 and may be moved to a position P2 close to the worker. In this case, for example, in confirming the instrument 4, even in a case where it becomes necessary to return to the movable body 300, since the movable body 300 is present near the worker, the worker can promptly access the movable body 300. For example, the management device 200 controls the movable body 300 such that the movable body 300 is located near the worker on the basis of the position information of the movable body 300 and the position information of the terminal device 100 held by the worker.

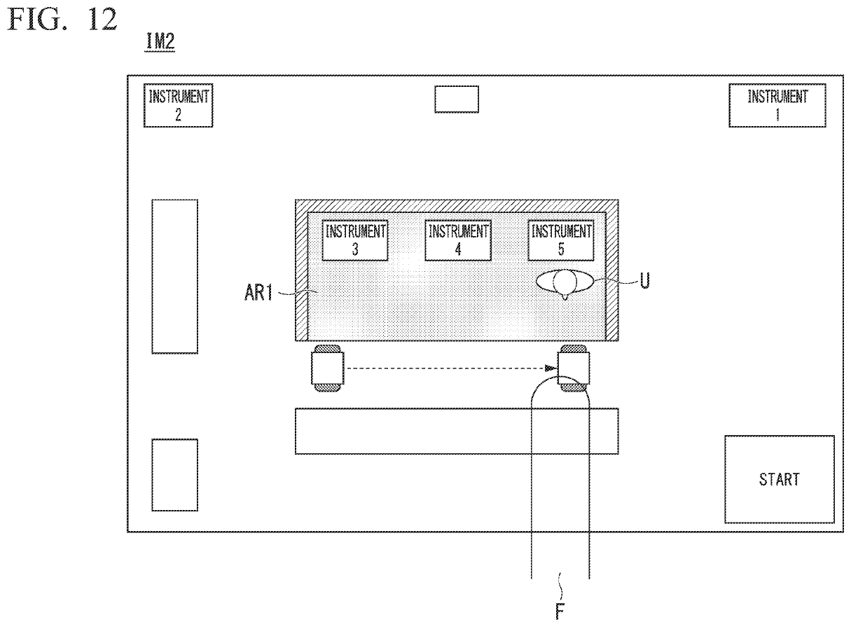

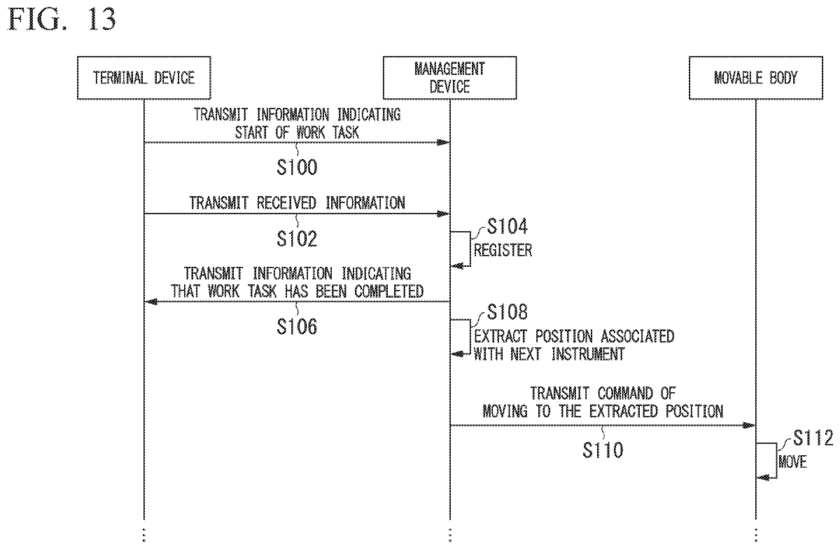

FIG. 11 is a view showing another example of a behavior of the movable body 300. For example, the movable body 300 moves to the vicinity of the instrument 5 after the worker gets off the movable body 300 near the instrument 3. In this case, for example, in a case where the worker watches the direction of the movable body 300 (the direction of the camera 350) for a predetermined period of time, the movable body 300 may move so as to approach the worker. For example, in a case where the management device 200 (or the control device 380 of the movable body 300) analyzes an image captured by the camera 350 and determines that the worker watches the direction of the movable body 300 for a predetermined period of time, the movable body 300 is controlled so as to approach the worker. The watching may be, for example, that the direction of the face of a worker that is registered in advance is directed in the direction of the movable body 300, may be that a predetermined portion (for example, the iris) of the face is directed in the direction of the movable body 300, or may be that both the face and the body of the worker are directed in the direction of the movable body 300. An image analysis of determining whether or not a worker watches may be, for example, a method of combining a characteristic quantity such as Haar-like feature or HOG (Histograms of Oriented Gradients), human detection by a learning device such as AdaBoost, and pattern recognition such as SVM (Support Vector Machine). However, another method may be used.

As shown in FIG. 11, after the movable body 300 moves to a position P3, in a case where the worker watches the movable body 300 for a predetermined period of time, the movable body 300 moves to a position P2. Thereby, convenience of the worker is improved.

FIG. 12 is a view showing an example of an image IM2 displayed on a display part of the terminal device 100. The image IM2 includes, for example, information in which the position of the worker U (terminal device 100) and the position of the movable body 300 are associated with the map information. When the worker swipes the icon to a position to which the worker wants to move the movable body 300 in the image IM in a state of touching an icon representing the movable body 300 using a finger F, the movable body 300 is moved to an actual position that corresponds to the swiped position. For example, the terminal device 100 transmits information regarding a swipe operation (for example, a movement direction and a movement amount in a screen, or trajectory information that is composite information of a movement direction and a movement amount) to the management device 200. The management device 200 converts information regarding the swipe operation into an actual movement direction and an actual movement distance of the movable body 300 and commands the movable body 300 to move on the basis of the converted result. Thereby, the movable body 300 moves to a position corresponding to the swipe operation.

As described above, since the worker can move the movable body 300 by a simple operation with respect to the terminal device 100, convenience of the worker is improved.

### Sequence View

FIG. 12 is a sequence view showing an example of a flow of a process performed by the movable body management system 1. This process is a process performed after the worker gets off the movable body 300. This process is an example of a process when the movable body 300 moves on the basis of a work schedule.

First, the terminal device 100 transmits start information indicating the start of a work task to the management device 200 (Step S100). The start information is, for example, information indicating that the icon IC1 has been operated and includes identification information of the instrument as the work target.

Next, after the process of Step S100, the terminal device 100 receives an input of information with respect to the icon IC2 and transmits the received information (for example, information indicated by the instrument) to the management device 200 (Step S102). Next, the management device 200 registers the information transmitted in Step S102 to the instrument information 256 (Step S104). Thereby, the management device 200 deems that the work task with respect to the target equipment has been completed.

When the work task has been completed, the management device 200 transmits information indicating that the work task has been completed to the terminal device 100 (Step S106). Next, the management device 200 extracts a position associated with the instrument which is the next work target (Step S108) and transmits a command (information based on information regarding the progress of the work task of the worker) of moving to the extracted position to the movable body 300 (Step S110). For example, the management device 200 generates the command described above on the basis of information regarding the progress of the work task of the worker and the work schedule that includes a plurality of work tasks. When acquiring the command transmitted in Step S110, the movable body 300 moves to the indicated position (Step S112). When acquiring predetermined information (for example, information of confirming the instrument or information indicating that a predetermined icon displayed on the display part of the terminal device 100 has been operated) in place of information indicating that the work task has been completed, the management device 200 may generate a command of moving the movable body 300 and transmit the generated command to the movable body 300.

In this way, the movable body 300 moves in accordance with the progress of the work task, and thereby, convenience of a worker is improved.

Although the above embodiment has been described using an example in which the movable body 300 moves on the basis of the work schedule, alternatively (or additionally), the movable body 300 may determine a target position of movement on the basis of the way of stepping when the worker gets off the movable body 300 to the ground and may move the target position. For example, the movable body 300 derives an attitude of a worker on the basis of a position or a change in the center of gravity of the worker obtained from a detection result of a gyroscope sensor or an IMU provided on the movable body 300 and determines whether the foot that is first placed on the ground when the worker gets off the movable body 300 is the right foot or the left foot on the basis of the derived result. When the worker first places the left foot on the ground, the movable body 300 moves toward a target position that is present in the left direction.

The target position is a position associated with a position where the worker gets off the movable body 300. This position is associated, for example, with a first position when the worker gets off the movable body 300 from the left foot and with a second position when the worker gets off the movable body 300 from the right foot. In a case where the worker gets off the movable body 300 from the left foot, the movable body 300 moves to the first position. In a case where the worker gets off the movable body 300 from the right foot, the movable body 300 moves to the second position.

The first position is a position (a position where it is estimated that the worker boards the movable body 300 next) to which it is estimated that the worker proceeds in a case where the worker gets off the movable body 300 from the left foot. The second position is a position to which it is estimated that the worker proceeds in a case where the worker gets off the movable body 300 from the right foot. Since the movable body 300 automatically moves to a position where the worker wants to ride the movable body 300 next, for example, the worker can further easily board the movable body 300 after performing a predetermined work task.

In this way, the movable body 300 moves on the basis of the motion of the worker, and thereby, convenience of the worker is improved.

According to the first embodiment described above, the control device 380 can realize useful control for the worker or a facility operation on the basis of information based on the input information that is input from the terminal device 100 by the worker in accordance with the work task.

### Second Embodiment

Hereinafter, a second embodiment is described. In the second embodiment, the movable body 300 moves close to the equipment as a work target prior to a worker. In other words, the movable body 300 guides the worker to access the equipment as the work target. Hereinafter, the difference from the first embodiment is mainly described.

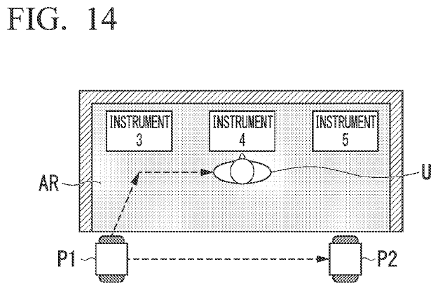

FIG. 14 is a view showing an operation of a movable body 300 according to the second embodiment. For example, a worker U confirms an instrument 3 and confirms an instrument 4. In this case, when the worker U is an inexperienced worker, the worker U may not recognize which instrument is to be confirmed next. For example, there may be a case in which the worker U cannot recognize whether it is necessary to confirm the instrument 5 or it is not necessary to confirm the instrument 5. In order to resolve such a situation, after the worker confirms the instrument 4, the movable body 300 moves to a position (for example, a position where the worker can easily board after confirming the instrument 5) associated with the instrument 5. The movable body 300 moves to the position associated with the instrument 5 to be confirmed next, and thereby, the worker recognizes that it is necessary to confirm the instrument 5.

For example, the movable body 300 moves on the basis of the command of the management device 200. In this case, the management device 200 moves the movable body 300 to a predetermined position in accordance with the progress of the work task of the worker U on the basis of the position information of the movable body 300, the position information of the terminal device 100 held by the worker U, and the work schedule.

In this way, the movable body 300 guides a user in accordance with the work task, and thereby, convenience of the user is improved.

The movable body 300 may use a speaker or the like and report, by way of speech, the information (information of the kind of work task, target equipment, a movement direction, and the like) regarding the next work task on the basis of the information acquired from the management device 200.

According to the second embodiment described above, the movable body 300 guides the worker such that the next work target is indicated, and thereby, convenience of the worker is improved.

### Third Embodiment

Hereinafter, a third embodiment is described. In the third embodiment, a worker or an administrator may operate, for example, a device such as a terminal device 100 and select a work task, the selected work task may be incorporated into a work schedule, and the incorporated work schedule may be displayed on the display part of the terminal device 100.

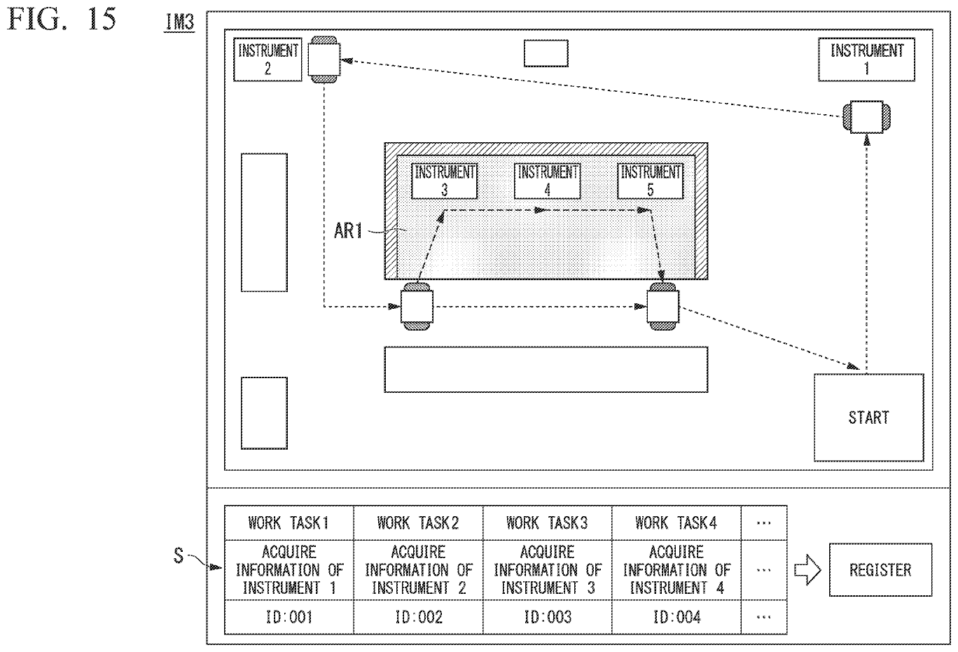

FIG. 15 is a view showing generation of a work schedule according to the third embodiment. An image IM3 shown in FIG. 15 is an image displayed on the display part of the terminal device 100. For example, the worker selects an instrument as a work target with reference to information in which map information and instrument are associated with each other included in the image IM3. Accordingly, the management device 200 acquires information based on the operation content of the worker and automatically generates a work schedule (S in the drawing) on the basis of the acquired information. In a case where the worker touches the instrument in the image IM3, a plurality of work tasks regarding the instrument may be displayed, and a target work task may be selected from among the plurality of work tasks.

For example, when generating the work schedule, the management device 200 determines the route of the movable body 300 on the basis of the position of the instrument included in the work schedule. For example, the management device 200 determines the order of stopping at the instruments such that a movement amount (a movement distance or a movement time) of the movable body 300 becomes small when stopping at the instruments included in the work schedule. The management device 200 transmits, to the terminal device 100, information for displaying information in which the generated route and the map information are associated with each other on the display part of the terminal device 100. Thereby, a route on which the movable body 300 is scheduled to move is provided to the worker as shown in the image IM3.

The worker may refer to the image IM3, operate the terminal device 100, and arbitrarily change the route or the order of the work task. In a case where the content, the order, the route, and the like of the work task are approved, when the worker operates a registration button included in the image IM3, the content, the order, the route, and the like of the work task described above are fixed. In this case, the management device 200 acquires information indicating that the registration button has been operated, incorporates the generated content of the work task, and moves the movable body 300 using the fixed order and route in cooperation with the terminal device 100 and the movable body 300.

In the embodiment described above, in place of (in addition to) the instrument being operated in the image IM, the work schedule may be generated by selecting the identification information of the work task. For example, when the worker selects the identification information of the work task associated with the content of the work task, the management device 200 generates a work schedule on the basis of the identification information of the operated work task.

The order or route of stopping at the instruments included in the work schedule described above may be determined on the basis of a past action history of the movable body 300. For example, the management device 200 determines the order or route of the work task in the current work schedule with reference to the action history at the time of performing the past work schedule that includes a work content which is the same as a work task to be performed. For example, the management device 200 determines an efficient order or route of the work task with reference to, from the past action history, an action history of a worker who is highly skilled at the work task, an order or route of the work task having a short time for completing the work schedule, and the like.

According to the third embodiment described above, since the movable body 300 moves based on a work schedule for efficiently moving that is generated based on the past history, the worker can efficiently perform the work task. For example, even a worker who is less skilled at the work task can easily and efficiently perform the work task. Further, since the worker can select the work task and generate the work schedule by operating the terminal device 100 (or another device), convenience of the worker is improved.

The embodiments described above can be represented as follows.

A control device controls a movable body which a worker who performs a work task at a workplace is capable of boarding and which is capable of traveling in a state where the worker is boarding, the control device including a storage device that stores a program and a hardware processor and being configured to: acquire information based on information regarding the progress of the work task of the worker; and control movement of the movable body based on the information which is acquired by executing the program.

Although the embodiments of the present invention have been described with reference to the drawings, the present invention is not limited to such embodiments, and various modifications and substitutions can be made without departing from the scope of the invention.

What is claimed is:

1. A movable body control device that controls a movable body on which a worker who performs a work task at a workplace is capable of boarding and which is capable of traveling in a state where the worker is boarding, the movable body control device comprising:
an acquisition part that acquires information based on information regarding a progress of the work task of the worker; and
a control part that controls movement of the movable body based on the information which is acquired by the acquisition part.

2. The movable body control device according to claim 1,
wherein the work task is a work task by which the worker confirms information that is indicated by equipment which is provided at the workplace.

3. The movable body control device according to claim 1,
wherein the information regarding the progress of the work task is information which is generated by operating a terminal device that is carried by the worker and that receives information which is input by the worker in accordance with the work task.

4. The movable body control device according to claim 1,
wherein the information regarding the progress of the work task is information indicating that the work task has started, information that is indicated by equipment as a target of the work task, information indicating that the worker has confirmed information that is indicated by equipment which is provided at the workplace, or information indicating that the work task has been completed.

5. The movable body control device according to claim 1,
wherein the control part moves the movable body to a position associated with a position of a work target at which the worker performs the work task based on the information acquired by the acquisition part.

6. The movable body control device according to claim 5,
wherein the position associated with the position of the work target at which the worker performs the work task is a position at which the worker is scheduled to arrive after getting off the movable body and then stopping at a plurality of work targets.

7. The movable body control device according to claim 1,
wherein the control part moves the movable body in accordance with the progress of the work task after the worker gets off the movable body, in accordance with information generated based on the information regarding the progress of the work task of the worker and a work schedule performed by the worker.

8. A movable body on which the movable body control device according to claim 1 is mounted.

9. A movable body management system, comprising:
the movable body control device according to claim 1; and
a server device that acquires the information regarding the progress of the work task of the worker and that provides information based on the information regarding the progress of the work task generated based on the acquired information to the movable body control device.

10. The movable body management system according to claim 9,
wherein the server device generates information based on the information regarding the progress of the work task for moving the movable body based on information regarding the progress of the work task of the worker and a work schedule including a plurality of work tasks and provides the generated information to the movable body control device.

11. A movable body control method by way of a computer that controls a movable body on which a worker who performs a work task at a workplace is capable of boarding and which is capable of traveling in a state where the worker is boarding, the movable body control method including:
acquiring information based on information regarding a progress of the work task of the worker; and
controlling movement of the movable body based on the information which is acquired.

12. A computer-readable non-transitory recording medium which includes a program causing a computer that controls a movable body on which a worker who performs a work task at a workplace is capable of boarding and which is capable of traveling in a state where the worker is boarding to:
acquire information based on information regarding a progress of the work task of the worker; and
control movement of the movable body based on the information which is acquired.
